(19) United States
(12) Patent Application Publication
(10) Pub. No.: US 2019/0230868 A1
(43) Pub. Date: Aug. 1, 2019

(54) GROW LIGHTING SYSTEM

(71) Applicant: Carson Technology Co., Ltd., Santa Fe Springs, CA (US)

(72) Inventor: Wess Hui-Shih Tao, Irvine, CA (US)

(73) Assignee: Carson Technology Co., Ltd., Santa Fe Springs, CA (US)

(21) Appl. No.: 15/882,236

(22) Filed: Jan. 29, 2018

Related U.S. Application Data
(60) Provisional application No. 62/623,096, filed on Jan. 29, 2018.

(51) Int. Cl. A01G 7/04; A01G 9/20; A01G 9/26

(52) U.S. Cl. CPC A01G 7/045; A01G 9/26; A01G 9/20

(57) ABSTRACT

A lighting system includes a support frame having first and second spaced-apart parallel elongate support channels and one or more elongate arms spanning and rigidly connecting the channels, a plurality of elongate electrical light emitters spanning the channels perpendicular thereto, having connectors at first and second distal ends thereof, and connected to the channels by the first and second connectors, respectively, wherein the connectors are adapted to allow movement of the light emitters along the channels while maintaining the light emitters perpendicular thereto.

### RELATED APPLICATION

This application claims priority to U.S. Provisional Application No. 62/623,096 filed earlier today, whose disclosure is incorporated herein by reference in its entirety.

### FIELD OF THE INVENTION

The invention is related to lighting for improved indoor agriculture. More specifically, the invention is related to lighting for most effectively growing cannabis.

### BACKGROUND

Recent changes in law have contributed to a sudden and drastic increase in cannabis agriculture and sales. According to Forbes Magazine, the marijuana market could increase by 700% before 2020 (https://www.forbes.com/sites/debraborchardt/2016/12/12/the-cannabis-market-that-could-grow-700-by-2020/#5770a834be1c).

Products related to the use and growth of marijuana are experiencing, and will likely continue to experience, a significant upsurge in sales. In particular, products which offer an improvement in efficacy, efficiency, and economy in the growth of marijuana will likely be subject to huge demand.

There exists the need for lighting which maximizes and accelerates that growth of cannabis, and such is an object of the invention. There exists the need for such lighting which is economical to purchase and operate, and such is an object of the invention. There exists the need for such lighting which is purchased in an unassembled state for reduced shipping cost, but is simple to assemble for use, and such is an object of the invention. There exists the need for such lighting that is expandable to adapt to the growth of larger numbers of cannabis plants or to the increased size of maturing plants, and such is an object of the invention.

Further needs and objects will become apparent upon reading the disclosure contained herein.

### SUMMARY OF THE INVENTION

The invention may be embodied in or practiced using a lighting system having a support frame with first and second spaced-apart parallel elongate support channels and one or more elongate arms spanning and rigidly connecting the support channels, a plurality of elongate electrical light emitters spanning the support channels perpendicular thereto, having connectors at first and second distal ends thereof, and connected to the support channels by the first and second connectors, respectively, wherein the connectors are adapted to allow movement of the light emitters along the support channels while maintaining the light emitters perpendicular thereto. The first support channel may have an electric supply cord, a first female electrical connector in electrical communication with the electric supply cord, and an elongate wire groove.

Each of the light emitters may have electrical wiring extending from the first distal end thereof. The wiring may have a second female connector identical to the first female connector and a male connector, and the wiring may be adapted to be received and contained within the wire groove. The male connector may be adapted to selectively mate electrically with either of the first or second female connectors. The male connector of a first of the light emitters may be mate-able electrically with the first female connector, and the male connector of a second of the light emitters may be mate-able electrically with the second female connector of the first of the light emitters, so that electrical power may be supplied to both the first and second light emitters.

The light emitters may be light-emitting diodes. The light emitting diodes may be equally longitudinally spaced surface mounted devices. The light emitting diodes may emit light of a plurality of wavelengths. The plurality of wavelengths may include wavelengths in the red, green, and blue spectrums. The wavelengths may be proportioned approximately 20% red, approximately 76% green, and approximately 4% blue.

The system may include elements for hanging the frame from there-above. The elements may be from the group including cables, wires, chains, straps, and lines.

The connectors may be hooks extending longitudinally outwardly from the light emitters and the support channels may further include elongate hook-receiving grooves there-along, the hook-receiving grooves disposed and configured to receive and support the hooks such that the light emitters may be moved along the support channels while remaining in a perpendicular disposition relative thereto.

The invention may also be embodied in or practiced using a lighting system having an elongate electrical light emitter with first and second distal ends having hooks extending longitudinally outwardly therefrom, the hooks configured and disposed to engage grooves of two parallel and spaced-apart support channels such that the light emitter is supported thereby and perpendicular thereto, such that the light emitters may be moved along the support channels while remaining in a perpendicular disposition relative thereto.

Further features and aspects of the invention are disclosed with more specificity in the Detailed Description and Drawings provided herein and showing exemplary embodiments of the invention.

### BRIEF DESCRIPTION OF THE DRAWINGS

Exemplary embodiments of a grow lighting system in accordance with or useful in practicing the invention are shown in the accompanying Drawings, of which;

FIG. 1 is a front perspective view of a first exemplary grow lighting system employing two light bars;

FIG. 2 is a front perspective view of the lighting system of FIG. 1 employing four light bars;

FIG. 3 is a front perspective view of the lighting system of FIG. 1 employing eight light bars;

FIG. 4 is a partial exploded view of the frame assembly of the system of FIG. 1;

FIG. 5 is a partial exploded view of the assembly of a light bar to the frame of the system of FIG. 1;

FIG. 6 is a partial view of the assembled light bar and frame of FIG. 5;

FIG. 7 is a partial view of the electrical connection of adjacent light bars of the system of FIG. 1; and

FIG. 8 is a view of an extension cord for optionally connecting distantly-separated adjacent light bars of the system of FIG. 1.

### DETAILED DESCRIPTION OF EXEMPLARY EMBODIMENTS

As appreciated by review of the included drawings, the invention may be embodied in or practiced using the exemplary grow lighting system 100 of the included drawings and the following description.

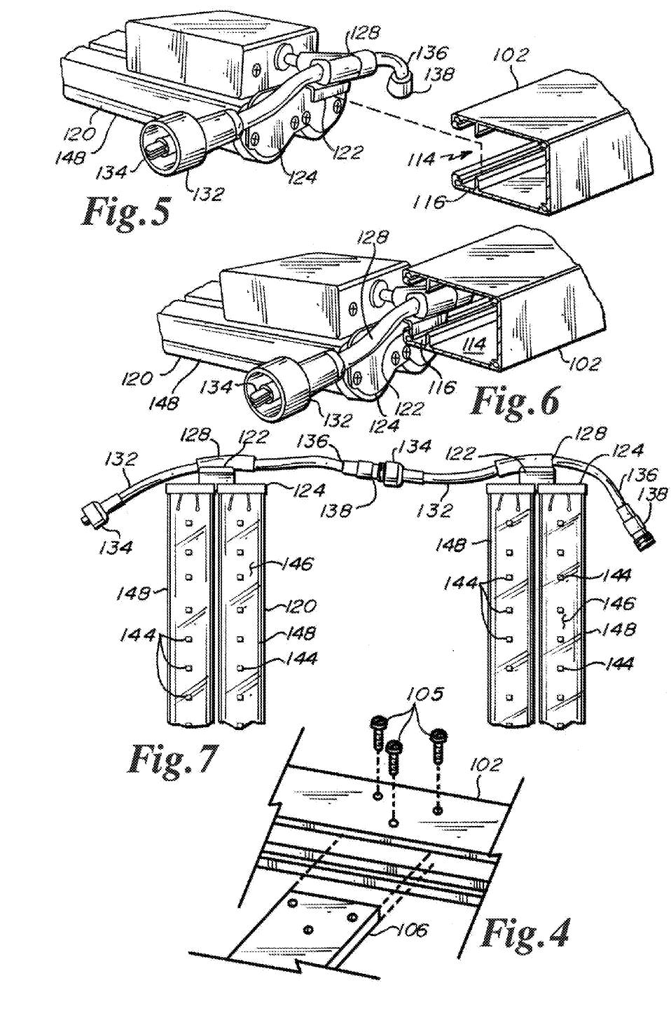

The system includes two elongate support channels (tracks), powered channel 102 and non-powered channel 104, which are rigidly disposed parallel to each other by fasteners 105 affixing the channels to cross bar 106 as shown in FIG. 4, to form a support frame. Other fastening means may alternatively be used within the invention, such as riveting, welding, adhesives, etc. The channels and cross bar are preferably made, predominantly, of extruded aluminum. Other materials or fabricating means may be used within the invention. The support frame is preferable hung from a ceiling or some other sufficiently strong overhead structure by cables 118, or may be affixed to a floor stand, affixed to a wall, or supported by some other means within the invention.

The powered and unpowered channels may be extruded from the same die and may be identical except that the powered channel includes a power cord 108 which is intended to be connected to a supply voltage for powering the system. Alternatively, two powered channels may be used is so desired under certain circumstances, such as to share the power load between two power cords.

The power cord preferably terminates externally at a typical AC plug 110, and internally at a female connector (not shown).

Best seen in FIGS. 5 and 6, the powered channel has a hollow interior which serves as a longitudinally continuous wire groove 114 that runs the length of the channel and is sufficiently wide and deep to receive and contain the wiring which will be later described.

Also best seen in FIGS. 5 and 6, both channels include a longitudinally continuous hook receiving groove 116 along the length of their bottom interior edges which are adapted to slidingly receive hooks of the lighting bars which will be later described.

Elongate light bars 120 each include a powered distal end 124 having wiring 128 extending therefrom and an unpowered distal end 126. Both distal ends include metal hooks 122 projecting outwardly which each include downwardly projecting tabs that are adapted to fit within and slidingly engage the hook receiving grooves 116. The tab of the hook at the unpowered end of each light bar is spaced from the tab of the hook at the powered end by a distance that is approximately equal to the distance between the parallel hook receiving grooves of the support channels so that the light bar, with its wiring disposed within wire groove 114 of the powered channel, may span across and be hooked to the support channels at the hook receiving channels and may be moved side-to-side while always remaining perpendicular to the elongate channels (and parallel to the cross bar).

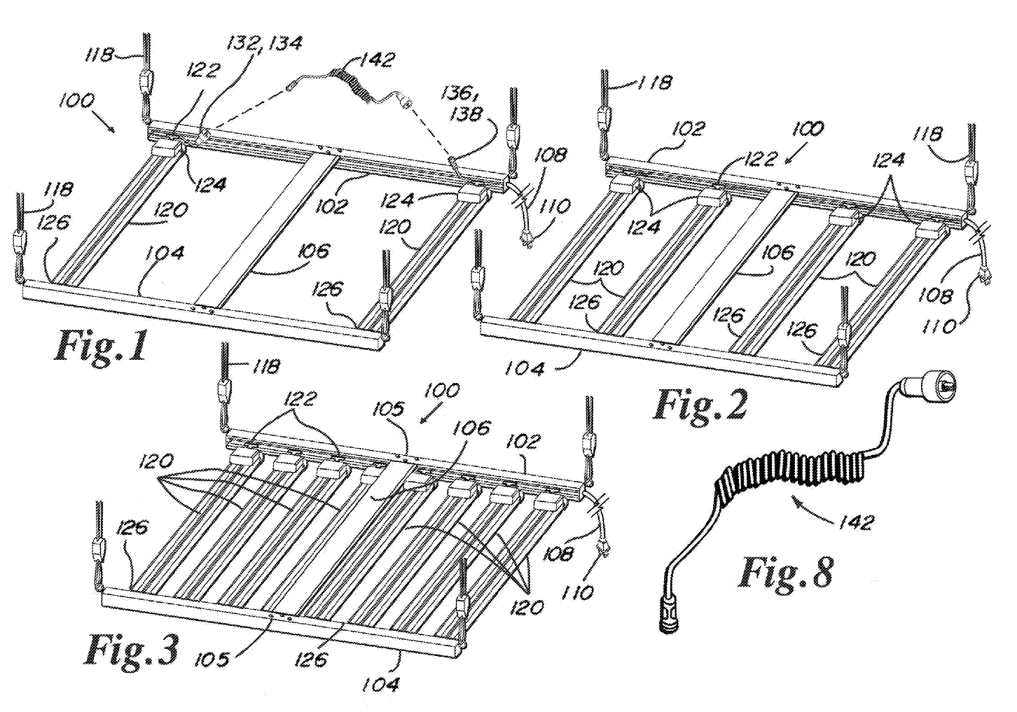

Any practical number (preferably two to eight in the disclosed exemplary embodiment) of light bars may be so-hung between the support channels and may be moved relative to the support channels and each other to most evenly light the plants (not shown) which would be positioned below. As shown in FIGS. 1-3, an even number of light bars evenly spaced apart and symmetrically spaced astride the cross bar is preferable, because that will best balance the system and put even strain on the support cables 118, but it is within the invention that any spacing, whether equal or unequal, and positioning, whether symmetrical or asymmetrical, and any practical number, whether even or odd, of light bars may be used within the invention. Additionally, the length of the support bars may be altered to provide fewer or more light bars, such a for industrial or home use, respectively, within the invention, and the light bar length, and the length of the cross bar accordingly may be altered within the invention to provide an assembly that is wider of thinner.

It is, for instance, anticipated that in an industrial environment where a large number of light bars are used, the two opposing support channels could both be powered channels, each having its own power cord. A number of the light bars could be positioned with their powered ends at one of the powered channels and the remaining light bars could be positioned with their powered ends at the other of the powered channels, to thereby share the power consumption between the two power cords and reduce the chances of drawing excessive power through one of the cords.

Referring to FIGS. 6 and 7, it can be seen that the wiring of each light bar consists of a wire cable having an input tail 132 with a male connector 134, having an output tail 136 with a female connector 138, and having a base wire (not shown) that extends from and into the light bar. The female connector is identical to the female connector (not shown) of the powered support channel, and the male connector is adapted to male physically and electrically with the male connector, although the male and female connectors of any one light bar will not be connected together. Their compatibility provides that a plurality of identical light bars may be electrically connected in series.

During assembly, the male connector of a first light bar closest to the power cord of the powered support channel is connected to the female connector of the powered support channel. Then the male connector of the next adjacent second light bar is connected to the female connector of the first light bar, and so on until all of the light bars are electrically connected in series. If the distance between the first and second light bars (or any of the adjacent light bars) is too great so that their connectors cannot reach each other, optional cord 142, having identical male and female connectors to male and female connectors 134 and 138, respectively, may be connected between the light bars.

The lighting of the light bars is provided by LEDs 144, which are preferably evenly disposed along and soldered to elongate PC board 146. An elongate lens 148 preferably covers and protects the LEDs and is preferably made of a transparent polymer. The LEDs are preferably surface mounted devices (SMDs), and the LEDs preferably emit in a variety of different wavelengths (colors) Most preferably, the LED's are arranged in a pattern of red, green and blue emitters so that the overall spectrum of the light provided to the plants has a ratio of 19.7% red, 76.6% green, and 3.7% blue, but other spectrums are within the invention.

The test report below provides the spectrum parameters of the exemplary embodiment, which, again, is meant to enable but not meant to limit the invention.

Spectrum Test Report

Specification: BFT-D02080GLM Staamnd. Sartdatus:

Instrument: HaasSuite (Everfine)

Test Conditions:
Temperature: 25.3Deg RH: 65.0%
WL Range: 380 nm-780 nm IP: 45966 (70%)
Test Mode: Fast Test T: 10 ms
Sensitivity: High

Spectrum

Colorimetric Parameters
Chromaticity Coordinate: x=0.3941 y=0.3788/u′=0.2333 v′=0.5045 (duv=−2.73e-03)
CCT=3662K Prcp WL: Ld=581.7 nm Purity=32.0%
Peak WL: Lp=594 nm FWHM: =160.2 nm Ratio: R=19.7% G=76.6% B=3.7%
Render Index: Ra=84.5
R1=83 R2=92 R3=96 R4=82 R5=83 R6=89 R7=85 R8=66 R9=18 R10=81 R11=80 R12=73 R13=86 R14=98 R15=78
LEVEL: OUT WHITE: ANSI_3500 K

Photometric & Radiometric Parameters
Flux=8193.81 m Eff.: 105.53 lm/W Fe=26.362 W Scotopic: 13287 S/P: 1.6216
Photons1: 1.246e+002 μmol/s (380˜780 nm) Photons2: 1.203e+002 μmol/s (400˜700 nm)
Photosynthetic: PPF (400˜700 nm): 119.14 μmol/s PRF (400-700 nm): 25278 mW
Eff (PPF) (400-700 nm): 1.53 μmol/s/W

Electrical Parameters
V=220.2 V I=0.3746 A P=77.64 W PF=0.9413 F=49.99 Hz

While the invention has been shown and described with reference to a specific exemplary embodiment, it should be understood by those skilled in the art that various changes in form and detail may be made without departing from the spirit and scope of the invention, and that the invention should therefore only be limited according to the following claims, including all equivalent interpretation to which they are entitled.

1. A lighting system comprising:
a support frame comprising first and second spaced-apart parallel elongate support channels and one or more elongate arms spanning and rigidly connecting the support channels;
a plurality of elongate electrical light emitters spanning the support channels perpendicular thereto, having connectors at first and second distal ends thereof, and connected to the support channels by the first and second connectors, respectively; wherein
the connectors are adapted to allow movement of the light emitters along the support channels while maintaining the light emitters perpendicular thereto; and wherein the first support channel comprises first electrical wiring contained entirely there-within to provide electrical power to the elongate light emitters, and an electric supply cord connected to and distinct from the first electrical wiring to provide electrical power thereto.

2. The system of claim 1 wherein the first support channel comprises the electric supply cord connected to the electrical wiring to provide electrical power thereto, a first female electrical connector in electrical communication with the electric supply cord, and an elongate wire groove.

3. The system of claim 2 wherein each of the light emitters has second electrical wiring distinct from the first electrical wiring and electrical supply cord, extending from the first distal end thereof.

4. The system of claim 3 wherein the second electrical wiring has a second female connector identical to the first female connector and a male connector, and the second electrical wiring is adapted to be received and contained within the wire groove.

5. The system of claim 4 wherein the male connector is adapted to selectively mate electrically with either of the first or second female connectors.

6. The system of claim 5 wherein the male connector of a first of the light emitters are matable electrically with the first female connector, and the male connector of a second of the light emitters are matable electrically with the second female connector of the first of the light emitters, so that electrical power is supplied to both the first and second light emitters.

7. The system of claim 6 wherein the light emitters comprise light-emitting diodes.

8. The system of claim 8 wherein the light emitting diodes comprise equally longitudinally spaced surface mounted devices.

9. The system of claim 8 wherein the light emitting diodes emit light of a plurality of wavelengths.

10. The system of claim 9 wherein the plurality of wavelengths include wavelengths in the red, green, and blue spectrums.

11. The system of claim 10 wherein the wavelengths are proportioned approximately 20% red, approximately 76% green, and approximately 4% blue.

12. The system of claim 11 further comprising elements for hanging the frame from there-above.

13. The system of claim 12 wherein the elements are from the group including cables, wires, chains, straps, and lines.

14. The system of claim 1 further comprising elements for hanging the frame from there-above.

15. The system of claim 14 wherein the elements are from the group including cables, wires, chains, straps, and lines.

16. The system of claim 15 wherein the connectors comprise hooks extending longitudinally outwardly from the light emitters and wherein the support channels further comprise elongate hook-receiving grooves there-along, the hook-receiving grooves disposed and configured to receive and support the hooks such that the light emitters are movable along the support channels while remaining in a perpendicular disposition relative thereto.

17. The system of claim 1 wherein the connectors comprise hooks extending longitudinally outwardly from the light emitters and wherein the support channels further comprise elongate hook-receiving grooves there-along, the hook-receiving grooves disposed and configured to receive and support the hooks such that the light emitters are movable along the support channels while remaining in a perpendicular disposition relative thereto.

18. A lighting system comprising an elongate electrical light emitter having first and second distal ends with hooks extending longitudinally outwardly therefrom, the hooks configured and disposed to engage grooves of two parallel and spaced-apart support channels such that the light emitter is supported thereby and perpendicular thereto, such that the light emitters are movable along the support channels while remaining in a perpendicular disposition relative thereto; and wherein at least one of the support channels comprises electrical wiring contained entirely there-within to provide electrical power to the elongate light emitter, and an electric supply cord connected to and distinct from the first electrical wiring to provide electrical power thereto.
